(19) United States
(12) Patent Application Publication
(10) Pub. No.: US 2017/0018344 A1
(43) Pub. Date: Jan. 19, 2017

(54) IRON POWDER FOR IRON POWDER CORES AND METHOD FOR SELECTING IRON POWDER FOR IRON POWDER CORES

(71) Applicant: JFE STEEL CORPORATION, Tokyo (JP)

(72) Inventors: Takuya Takashita, Chiba (JP); Naomichi Nakamura, Chiba (JP)

(73) Assignee: JFE STEEL CORPORATION, Tokyo (JP)

(21) Appl. No.: 15/301,078

(22) PCT Filed: Mar. 27, 2015
(86) PCT No.: PCT/JP2015/001783

§ 371 Date: Sep. 30, 2016

(30) Foreign Application Priority Data
Apr. 2, 2014 (JP) 2014-075946

(51) Int. Cl. H01F 1/20; B22F 1/00; C22C 38/18; H02K 1/02; C22C 38/06; C22C 38/02; H01F 1/147; H01F 41/02; B22F 1/02; C22C 38/04

(52) U.S. Cl. CPC H01F 1/20; B22F 1/02; B22F 1/0014; C22C 38/18; C22C 38/04; C22C 38/06; C22C 38/02; H01F 1/14791; H01F 41/0246; H02K 1/02

(57) ABSTRACT

Provided is an iron powder for iron powder cores, and a method for selecting the same. The following powder is an iron powder in which orientations are measured in a cross section of a compact formed with a molding pressure of 0.98 GN/m² by electron backscatter diffraction (EBSD) and the average of KAMs calculated using EBSD analysis software is to 3.00° or less. The Iron powder has a particle size distribution in which particles with a size of 45 μm or less are adjusted to 10% by mass or less, in which the average hardness of powder particles is 80 HV 0.025 or less in Vickers hardness, in which the product of the number (inclusions/m²) of inclusions per unit area and the median size D50 (m) of the inclusions is 10,000 (inclusions/m) or less, and which has an apparent density of 4.0 Mg/m³ or more.

### CROSS REFERENCE TO RELATED APPLICATIONS

This is the U.S. National Phase application of PCT/JP2015/001783, filed Mar. 27, 2015 and claims priority to Japanese Patent Application No. 2014-075946, filed Apr. 2, 2014, the disclosures of each of these applications being incorporated herein by reference in their entireties for all purposes.

### FIELD OF THE INVENTION

The present invention relates to iron powders for iron powder cores and particularly relates to an iron powder, suitable for manufacturing an iron powder core with low iron loss, for iron powder cores and a method for selecting the iron powder.

### BACKGROUND OF THE INVENTION

Magnetic cores for use in motors and transformers are required to have properties such as high magnetic flux density and low iron loss. Conventionally, the magnetic cores used have been those formed by stacking electrical steel sheets. However, in the case where a magnetic core is formed by stacking electrical steel sheets, a degree of freedom in shape is limited. Also as the electrical steel sheets used are surface-insulated, there is a problem in that magnetic properties differ in a direction parallel to a surface of each steel sheet and a direction perpendicular to the steel sheet surface and magnetic properties in the direction perpendicular to the steel sheet surface are poor.

Therefore, in recent years, iron powder cores for motors have been attracting attention.

An iron powder core is manufactured in such a manner that insulation-coated soft magnetic particles (iron powder) are loaded into a die and then press-molded. Therefore, the iron powder core needs only the die, has a higher degree of freedom in shape as compared to a magnetic core formed by stacking electrical steel sheets, and can be used to form a three-dimensional magnetic circuit. In addition, the iron powder core has advantages that inexpensive soft magnetic particles (iron powder) can be used and manufacturing steps are shorter and are advantageous in cost. Furthermore, soft magnetic particles (iron powder) used in the iron powder core are each covered with an insulating coating, are advantageous in that magnetic properties are uniform in all directions, and are suitable for forming a three-dimensional magnetic circuit.

From these, motors including a three-dimensional magnetic circuit using an iron powder core are recently under active development from the viewpoints of the downsizing of motors, rare earth-free products, cost reduction, and the like.

However, there is a problem in that iron powder cores have higher hysteresis loss as compared to magnetic cores formed by stacking electrical steel sheets. Therefore, the iron powder cores are required to have reduced hysteresis loss and enhanced iron loss properties. The hysteresis loss is affected by the strain remaining in material, impurities, the size of grains, and the like. In particular, the influence of the remaining strain and the grain size is known to be significant. Therefore, when large strain remains or the grain size is small, the iron loss increases significantly.

In order to cope with such requirements, for example, Patent Literatures 1 and 2 describe that the hysteresis loss can be reduced in such a manner that a soft magnetic material containing magnetic metal particles is compression-molded multiple times and is annealed after compression molding each time, the strain introduced in the final press molding step is appropriately adjusted, the reduction in size of grains by working and recrystallization is minimized, and the coarsening of the grains is achieved. However, Patent Literatures 1 and 2 do not at all refer to properties of an iron powder used.

For iron powders for iron powder cores, for example, Patent Literature 3 discloses an insulation-coated iron powder for iron powder cores. The insulation-coated iron powder contains iron particles, whose surface is coated with an insulating layer, having hardness of 75 or less in micro-Vickers hardness Hv. According to a technique disclosed in Patent Literature 3, the iron particles are extremely low in hardness and therefore have high compressibility; hence, an iron powder core with higher density than ever before can be obtained. As a result, an iron powder core which has iron loss substantially equal to that of conventional products and higher magnetic flux density than ever before is obtained.
PTL 1: Japanese Unexamined Patent Application Publication No. 2009-290024
PTL 2: Japanese Unexamined Patent Application Publication No. 2012-119708
PTL 3: Japanese Unexamined Patent Application Publication No. 2005-187918

### SUMMARY OF THE INVENTION

However, in techniques disclosed in Patent Literatures 1 and 2, there is a problem in that productivity is low and manufacturing cost is very high because compression molding and annealing need to be performed multiple times. In the technique disclosed in Patent Literature 3, although an iron powder core with high magnetic flux density is obtained, there is a problem in that the iron powder core has poor iron loss properties.

The present invention solves these conventional technical problems and has an object to provide an iron powder for iron powder cores as a source powder for iron powder cores. The iron powder is capable of manufacturing an iron powder core having low iron loss and particularly low hysteresis loss. Incidentally, the term “low iron loss” refers to an iron loss of less than 80 W/kg, which is equal to or less than the iron loss of an iron powder core prepared by stacking electrical steel sheets having a thickness of 0.35 mm.

In order to achieve the above object, the inventors have intensively investigated various factors affecting the iron loss of iron powder cores. As a result, the inventors have focused on the fact that, in order to obtain an iron powder core having low iron loss, the strain accumulated in an iron powder needs to be minimized when a compact (iron powder core) is formed. Therefore, the inventors have appreciated that the strain in powder particles in the compact needs to be evaluated. The inventors have found that KAM (Kernel Average Misorientation) value determined in a cross section of a compact obtained by molding a source powder with a predetermined pressing pressure (molding pressure) strongly correlates with the grain size after recrystallization annealing, thereby appreciating that the KAM is used as an indicator for the strain accumulated in an iron powder during molding.

The inventors have performed further investigations to find that in the case where a target source powder (iron powder) is molded into a compact with a predetermined molding pressure, a cross section of the obtained compact is measured for KAM, and the average KAM is 3.00° or less, the strain accumulated in the iron powder is small, recrystallized grains are coarsened, and the iron loss of the compact (iron powder core) is reduced. Furthermore, the inventors have found that the predetermined molding pressure is preferably 0.98 GN/m² because the strain distribution in a microstructure is uniform and a stable KAM is obtained.

The present invention has been completed on the basis of these findings in addition to further investigations. That is, aspects of the present invention are as described below.

(1) An iron powder for iron powder cores is one in which orientations are measured in a cross section of a compact formed with a molding pressure of 0.98 GN/m² by electron backscatter diffraction (EBSD) and an average of KAMs (Kernel Average Misorientations) calculated from measurement results of the orientations using EBSD analysis software is 3.00° or less.
(2) The iron powder for iron powder cores specified in Item (1), wherein the iron powder contains 10% by mass or less of particles with a size of 45 μm or less, an average hardness is 80 HV 0.025 or less in Vickers hardness, a product of the number (inclusions/m²) of inclusions per unit area and the median size D50 (m) of the inclusions is 10,000 (inclusions/m) or less, and apparent density is 4.0 Mg/m³ or more.
(3) The iron powder for iron powder cores specified in Item (1) or (2), wherein the iron powder contains 0.01% or less Al, 0.01% or less Si, 0.1% or less Mn, and 0.05% or less Cr on a mass basis, the remainder being Fe and inevitable impurities.
(4) The iron powder for iron powder cores specified in any one of Items (1) to (3), wherein the iron powder has an insulating coating layer on a surface.
(5) In the iron powder for iron powder cores specified in Item (4), wherein the insulating coating layer is a silicone coating layer.
(6) In the iron powder for iron powder cores specified in Item (5), wherein the silicone coating layer is 0.1 parts by mass or more with respect to 100 parts by mass of the iron powder for iron powder cores.
(7) A method for producing an iron powder for iron powder cores includes an atomizing step of atomizing molten metal having a composition mainly containing iron into an atomized powder, a decarburization-reduction annealing step of subjecting the atomized powder to decarburization-reduction annealing, a pulverizing step of pulverizing the atomized powder subjected to decarburization-reduction annealing, and a stress-relief heat treatment step of relieving the strain of the pulverized atomized powder to form a powder mainly containing iron. The pulverization is performed using a pulverization apparatus equipped with a rotating body such that the product of the peripheral speed of the rotating body and the treatment time (peripheral speed (m/s)×treatment time (s)) is 1,000 m to 22,000 m.
(8) The method for producing the iron powder for iron powder cores specified in Item (7), wherein the molten metal contains 0.01% or less Al, 0.01% or less Si, 0.1% or less Mn, and 0.05% or less Cr on a mass basis, the remainder being Fe and inevitable impurities.
(9) The method for producing the iron powder for iron powder cores specified in Item (7) or (8), wherein an insulating coating treatment for forming an insulating coating layer on the surface of the obtained powder mainly containing iron is performed.
(10) The method for producing the iron powder for iron powder cores specified in Item (9), wherein the insulating coating layer is a silicone resin coating layer.
(11) The method for producing the iron powder for iron powder cores specified in Item (10), wherein the silicone resin coating layer is 0.1 parts by mass or more with respect to 100 parts by mass of the powder mainly containing iron.
(12) A method for selecting an iron powder for iron powder cores includes molding a target iron powder into a compact, measuring orientations in a cross section of the compact by electron backscatter diffraction (EBSD), and evaluating an iron powder capable of manufacturing a low-iron loss iron powder core using KAMs (Kernel Average Misorientations) calculated from measurement results of the orientations by using EBSD analysis software.
(13) A method for selecting an iron powder for iron powder cores includes molding a target iron powder into a compact with a molding pressure of 0.98 GN/m², measuring orientations in a cross section of the compact by electron backscatter diffraction (EBSD), and evaluating the iron powder as capable of manufacturing a low-iron loss iron powder core when the average of KAMs (kernel average misorientations) calculated from measurement results of the orientations by using EBSD analysis software is 3.00° or less.

According to aspects of the present invention, an iron powder for iron powder cores can be provided as a source powder for iron powder cores. The iron powder is capable of manufacturing an iron powder core with low iron loss and particularly low hysteresis loss. Furthermore, according to an aspect of the present invention, a compact in which a strain accumulated in an iron powder is suppressed to a low level can be obtained and an iron powder core with low iron loss can be readily obtained by subsequent stress relief annealing. This provides industrially remarkable effects.

### DETAILED DESCRIPTION OF EMBODIMENTS OF THE INVENTION

In the present invention, KAM may be used as an indicator for the strain accumulated in a powder (hereinafter also referred to as an iron powder), mainly containing iron, in a compact. The KAM is a value calculated from measurement results of orientations of powder particles using EBSD analysis software (OIM Analysis developed by TSL Solutions), and the orientations being measured for a compact which is a measured target in a scanning electron microscope by electron backscatter diffraction (EBSD) (EBSD measurement). The KAM means an average misorientation between an arbitrary measurement point and a surrounding measurement point.

If dislocations are introduced into a crystal by working, a small misorientation is induced in the crystal. As the KAM is smaller, the strain accumulated in a crystal is smaller. The strain applied to the crystal, which is a measured target, can be evaluated by determining the KAM.

First, a method for measuring the KAM is described.

An iron powder (target iron powder) intended for iron powder cores is molded into a compact at 10 t/cm² (0.98 GN/m²). An about 5-10 mm square sample is cut out of the obtained compact. The sample is embedded in a thermosetting resin containing carbon such that an observation surface is perpendicular to a compression direction. The embedded compact (sample) is first polished with water-resistant paper and is then polished with a diamond buff (a particle size of 3 μm), an alumina buff (a particle size of 3 μm), and an alumina buff (a particle size of 1 μm) in that order. Incidentally, it is needless to say that care is taken to avoid inducing strain in the sample. There is no problem if colloidal silica polishing and electropolishing are performed as required.

The polished sample is immediately subjected to EBSD analysis in a scanning electron microscope (SEM). The SEM to be used is preferably equipped with a field-emission filament. This is because it is difficult to measure a locally highly strained region using a filament with a large beam diameter like a tungsten filament. In order to perform EBSD analysis, the SEM should be equipped with an OIM (orientation imaging microscopy) system.

The polished sample is loaded into the SEM equipped with the OIM system, followed by performing the EBSD analysis of the observation surface. In the EBSD analysis, the misorientation between an arbitrary point in a field of view with a size of, for example, about 500 μm×500 μm and a first adjacent point around the arbitrary point is measured with an analysis step of 0.25 μm and the misorientation between the arbitrary point and a second adjacent point outside the first adjacent point is measured. This is performed in sequence to a tenth adjacent point. In order to increase the precision of measurements, the analysis of such a field of view is preferably performed for the same sample in two or more fields of view.

The KAM analysis of the observation surface is performed from obtained measurement results (EBSD). EBSD analysis software (OIM Analysis developed by TSL Solutions) is used for KAM analysis. In the calculation of the KAM, among obtained measurements, measurement points which have a CI (confidence index) of 0.2 or less and which are low in reliability are eliminated. In order to limit measurement in a grain and in order to eliminate grain boundaries, the maximum misorientation is set to 5°. All measurement points including up to the tenth adjacent point are used. This is because the KAM is determined at a maximum number of measurement points in minimum steps for the purpose of reducing the error of analysis.

The above KAM analysis is performed in all measured fields of view and the arithmetic mean of KAMs determined in all the measured fields of view is determined, whereby the average KAM of a target is obtained.

An iron powder according to one embodiment of the present invention is an iron powder (powder mainly containing iron) in which the average KAM is 3.00° or less as determined in a cross section of a compact, formed with a molding pressure of 0.98 GN/m², by the above method. When the average KAM is more than 3.00°, grains after stress relief annealing are fine, the hysteresis loss of an iron powder core is high, the iron loss is high, and iron loss properties of a magnetic core are deteriorated. Therefore, in one embodiment of the present invention, an iron powder for iron powder cores is limited to the iron powder (powder mainly containing iron) in which the average KAM is 3.00° or less as determined in the cross section of the compact, formed with a molding pressure of 0.98 GN/m², by the above method. The average KAM is preferably 2.5° or less. The lower limit of the KAM is not particularly limited and is preferably low. The lower limit thereof is preferably 1.00°.

A compact measured for KAM is one formed with a molding pressure of 10 t/cm² (0.98 GN/m²). When the molding pressure is 0.98 GN/m², the strain distribution in a microstructure can be made more uniform, measurement variations are more reduced, and strain can be readily measured in a smaller number of fields of view as compared to when the molding pressure is more than 0.98 GN/m². Furthermore, when the molding pressure is 0.98 GN/m², the difference in KAM between a preferable iron powder and a non-preferable iron powder can be made larger and whether an iron powder is good can be more readily decided as compared to when the molding pressure is less than 0.98 GN/m². Incidentally, it is needless to say that the molding pressure is not limited to this value when an iron powder is actually formed.

An example of the iron powder, in which the average of KAMs calculated in the cross section of the compact formed with a molding pressure of 0.98 GN/m² using the above EBSD analysis software is 3.00° or less, according to an embodiment of the present invention is an iron powder which contains 10% by mass or less of particles with a size of 45 μm or less, in which the average hardness of powder particles is 80 HV 0.025 or less in Vickers hardness, in which a product of the number (inclusions/m²) of inclusions per unit area of each powder particle and the median size D50 (m) of the inclusions is 10,000 (inclusions/m) or less, and which has an apparent density of 4.0 Mg/m³ or more.

The iron powder (powder mainly containing iron) according to the present invention preferably has a particle size distribution in which the particles with a size of 45 μm or less are adjusted to 10% by mass or less. In fine particles with a size of 45 μm or less, a strain is likely to be accumulated during compacting. Therefore, such fine particles are preferably minimized. When the particles with a size of 45 μm or less are 10% by mass or less, the strain accumulated in the iron powder does not increase so as to produce fine grains after stress relief annealing. Therefore, in the iron powder according to an embodiment of the present invention, the particles with a size of 45 μm or less are preferably limited to 10% by mass or less. The particles with a size of 45 μm or less are more preferably 5% by mass or less. The percentage of the particles with a size of 45 μm or less can be determined in such a manner that sieving is performed using a sieve specified in JIS Z 8801-1.

The iron powder according to the present invention is preferably one in which the average hardness of powder particles is 80 HV 0.025 or less in Vickers hardness.

The fact that the hardness of powder particles indicates that strain is accumulated in powder or grains in powder are fine. When strain is accumulated in powder or grains in powder are fine, an increase in strain accumulated during molding is caused. Therefore, in order to reduce the strain accumulated during molding, the powder particles are preferably made as soft as possible. In view of this, powder particles of the iron powder according to the present invention preferably have an average hardness of 80 HV 0.025 or less in Vickers hardness. The powder particles of the iron powder according to the present invention more preferably have an average hardness of 75 HV 0.025 or less in Vickers hardness.

A method for measuring the Vickers hardness is as described below.

First, an iron powder which is a measured target is mixed with a thermoplastic resin powder, whereby a powder mixture is prepared. After the powder mixture is loaded into an appropriate die, resin is melted by heating and is then solidified by cooling, whereby a specimen for hardness measurement is prepared. The specimen for hardness measurement is cut along an appropriate cross section and is polished. A working layer due to polishing is preferably removed by corrosion.

Powder particles are measured for hardness with a load of 25 gf (0.245 N) in accordance with JIS Z 2244 using a Vickers hardness tester. A point in each particle is measured for hardness. At least ten of the powder particles are measured for hardness and the average thereof is defined as the hardness of the iron powder. The powder particles, which are measured, should have a size sufficient to contain an indentation and preferably have a size of 100 μm or more.

The iron powder according to the present invention is preferably one in which the product of the number (inclusions/m²) of inclusions per unit area of each powder particle and the median size D50 (m) of the inclusions is 10,000 (inclusions/m) or less.

The inclusions in the iron powder are oxides containing one or more of Mg, Al, Si, Ca, Mn, Cr, Ti, Fe, and the like. The inclusions in the iron powder can be a factor accumulating strain. As the size of the inclusions is larger or the number of inclusions is larger, this tendency is more significant. Therefore, the inclusions in the iron powder are preferably minimized in size and reduced in amount.

In view of this, in the iron powder according to an embodiment of the present invention, it is preferable that the median size D50 (m) of the inclusions is determined from the number NA (inclusions/m²) of the inclusions per unit area of each powder particle and the size distribution of the inclusions and the product {the number NA (inclusions/m²) of the inclusions per unit area×the median size D50 (m)} is a predetermined value or less. In an iron powder in which the product is more than 10,000 (inclusions/m), the strain accumulated in powder particles increases during molding; hence, it is difficult to manufacture an iron powder core with a desired low iron loss. Therefore, in the iron powder according to the present invention, {the number NA (inclusions/m²) of the inclusions per unit area×the median size D50 (m)} is preferably limited to 10,000 (inclusions/m) or less. The product of the number (inclusions/m²) of the inclusions per unit area×the median size D50 (m) of the inclusions is more preferably 7,000 (inclusions/m) or less. The lower limit of the product is not particularly limited and is preferably 5,000 (inclusions/m) or less for the purpose of enabling industrial production.

Methods for measuring the number of the inclusions per unit area and the median size D50 (m) of the inclusions are as described below.

First, an iron powder which is a measured target is mixed with a thermoplastic resin powder, whereby a powder mixture is prepared. After the powder mixture is loaded into an appropriate die, resin is melted by heating and is then solidified by cooling, whereby an iron powder-containing resin solid is prepared. The iron powder-containing resin solid is cut along an appropriate cross section. After the cross section is polished and is then corroded, a cross-sectional microstructure of each particle in the iron powder is observed with a backscattered electron image using a scanning electron microscope (a magnification of 1,000 times to 5,000 times) and at least five fields of view are imaged. In the backscattered electron image, inclusions are observed with a black contrast. In each obtained field of view, image processing is performed and a size below and above which the number of inclusions becomes equal, that is, the median size D50 (m) is determined from the number (inclusions/m²) of the inclusions per unit area and a size distribution of the inclusions. The term “median size D50 of inclusions” as used herein refers to a size at which a larger side and a smaller side are equal in amount in the case where a size distribution of the inclusions is determined and is halved at a certain size. The size of the inclusions used is the equivalent circle diameter approximated from the area of each inclusion. Values obtained in each field of view are averaged and the average is used as a value of the iron powder.

The iron powder according to the present invention is preferably one having an apparent density of 4.0 Mg/m³ or more.

An increase in apparent density reduces the strain accumulated in the powder particles when the compact is formed. Therefore, the apparent density is preferably 4.0 Mg/m³ or more. The apparent density is more preferably 4.2 Mg/m³ or more. The apparent density is an indicator showing the degree of the filling factor of powder and is preferably high. The upper limit of the apparent density may be 5.0 Mg/m³ in terms of industrial availability. The apparent density used is a value obtained by a testing method specified in JIS Z 2504.

The composition of the iron powder for iron powder cores according to aspects of the present invention is not particularly limited if the average of KAMs obtained in a cross section of a compact formed with a molding pressure of 0.98 GN/m² is 3.00° or less, e.g., as described above. The composition of the iron powder may be one containing 0.001% to 0.02% C, 0.01% or less Si, 0.1% or less Mn, 0.001% to 0.02% P, 0.02% or less S, 0.01% or less Al, 0.01% or less N, 0.1% or less 0, and 0.05% or less Cr on a mass basis, the remainder being Fe and inevitable impurities.

A non-limiting example of a method for producing an iron powder (powder mainly containing iron) which has the above properties and which is suitable as a source powder for iron powder cores with low iron loss is described below.

In an embodiment of the present invention, the iron powder (powder mainly containing iron), which is used as a source powder for iron powder cores, can be obtained by performing an atomizing step of atomizing molten metal into an atomized powder (atomized iron powder), a decarburization-reduction annealing step of subjecting the obtained atomized powder to decarburization-reduction annealing, a pulverizing step of pulverizing the atomized powder subjected to decarburization-reduction annealing, and a stress-relief heat treatment step.

In an embodiment of the present invention, the powder (iron powder) mainly containing iron is used as a source powder for iron powder cores and may be powder (iron powder) obtained by an atomizing method. The atomizing method may be a gas-atomizing method, a water-atomizing method, or the like. A method for producing powder is not particularly limited. In consideration of productivity and economic efficiency, powder obtained by the water-atomizing method or the gas-atomizing method is preferable. Powder obtained by an oxide reduction method or an electrolytic deposition method has low apparent density and therefore it is difficult to ensure a desired apparent density.

In the atomizing step, molten metal (molten steel) mainly containing iron may be produced in an electric furnace or the like by a usual steelmaking process.

Molten metal (molten steel) may mainly contain iron and the composition thereof is not particularly limited. However, since large amounts of oxide inclusions may possibly be produced during atomization, molten metal containing minimal amounts of oxidizable metal elements (Al, Si, Mn, Cr, and the like) is preferable. Molten metal is preferably adjusted so as to contain 0.001% to 0.5% C, 0.01% or less Si, 0.1% or less Mn, 0.001% to 0.02% P, 0.02% or less S, 0.01% or less Al, 0.001% to 0.1% N, 0.5% or less 0, and 0.05% or less Cr on a mass basis, the remainder being Fe and inevitable impurities. When the amount of each of the oxidizable metal elements (Al, Si, Mn, Cr, and the like) is outside the above preferable range, large amounts of oxide inclusions are generated to serve as sites where strain is accumulated during molding, grains are likely to become fine after stress relief annealing, an iron powder core with low iron loss is unlikely to be obtained. The amount of an oxidizable metal element other than Al, Si, Mn, and Cr is preferably minimized.

Molten metal produced so as to have a desired composition may be atomized in a usual atomized powder production line, whereby powder (atomized iron powder) is obtained.

In the decarburization-reduction annealing step, the obtained powder (atomized iron powder) may be dried and subjected to decarburization-reduction annealing.

Decarburization-reduction annealing may be a usual treatment in reducing atmosphere containing hydrogen and treatment conditions are not particularly limited. For example, a heat treatment is preferably performed at a temperature 700° C. to lower than 1,200° C., preferably 900° C. to lower than 1,100° C., for a holding time of 1 h to 7 h, preferably 2 h to 5 h, in the reducing atmosphere containing hydrogen once or multiple times. In order to perform decarburization, the dew point of an atmosphere is preferably 30° C. or higher and wet hydrogen is preferable. After decarburization is sufficiently performed, a dry hydrogen atmosphere with a dew point of −30° C. or lower is preferable in order to prevent oxidation and the like.

The obtained powder (atomized iron powder) may be partly aggregated by decarburization-reduction annealing and can be crushed in a hummer mill or the like. This treatment has an effect of coarsening grains in the powder (atomized iron powder).

Then, in the pulverizing step, pulverization may be performed for the purpose of spheroidizing powder. In an embodiment of the present invention, pulverization is preferably performed using a pulverization apparatus, equipped with a rotating body, capable of applying strong shear force to each powder in addition to pulverization using an impact pulverization apparatus, such as a hummer mill, usually used. Examples of the pulverization apparatus equipped with the rotating body include a Henschel mixer, a pulverizer, an impeller mill, and a high-speed mixer. In these pulverization apparatuses, strong shear force can be applied to powder with a rotating body (blade or rotor). However, if shear force is excessively applied to powder, then a lot of strain is introduced into the powder and a subsequent stress-relief heat treatment induces recrystallization to cause grains to become fine in some cases. Causing grains to become fine increases the hardness of powder. Even if powder is spheroidized, the KAM after molding exceeds 3.00° in some cases.

Therefore, in an embodiment of the present invention, pulverization is preferably performed using a rotating body under such conditions that the product of the peripheral speed of the rotating body and the treatment time (peripheral speed (m/s)×treatment time (s)) is 1,000 m to 22,000 m. When the product is less than 1,000 m, the apparent density is less than 4.0 Mg/m³, and whereby it is difficult to obtain an iron powder core with a desired low iron loss in some cases. However, when the product is more than 22,000 m, a lot of strain is introduced into powder, the hardness increases, and the KAM during powder molding is more than 3.00° in some cases. The term “peripheral speed of rotating body” as used herein refers to the peripheral speed of the outer edge of each rotary blade. The number of the rotary blades is not particularly limited.

Next, in the stress-relief heat treatment step, in order to relieve the strain introduced into powder by pulverization, the stress-relief heat treatment of the obtained powder may be performed. Relieving the strain reduces the hardness of the powder, and thereby enabling the KAM after molding to be adjusted to, e.g., 3.00° or less. The stress-relief heat treatment is preferably performed at a temperature for a time such that powder is not aggregated. The stress-relief heat treatment is not particularly limited and is preferably performed at lower than 900° C. for 90 min or less. When the temperature of the stress-relief heat treatment is 900° C. or higher, powder is likely to be aggregated. In the case where the stress-relief heat treatment is performed at lower than 500° C., the temperature is low and therefore the strain is not relieved in some cases. Therefore, the stress-relief heat treatment is preferably performed at 500° C. or higher. When the time of the stress-relief heat treatment is short, the strain is not relieved in some cases. Therefore, the time thereof is preferably 10 min or more. In order to prevent the oxidation of powder, the stress-relief heat treatment is preferably performed in a reducing atmosphere containing hydrogen. The dew point of an atmosphere is preferably −30° C. or lower.

The obtained powder (iron powder), which mainly contains iron, may be subjected to an insulating coating-forming step of forming an insulating coating layer on a surface for iron powder core use.

The insulating coating-forming step may be performed by a treating method capable of covering the surface of each powder particle in the iron powder with an insulating coating material to form an insulating coating layer and is preferably performed by an appropriate method depending on the type of the insulating coating material. When the insulating coating material is, for example, resin, the following method can be exemplified: a method in which the insulating coating layer is formed on the surface of the iron powder in such a manner that a dilute resin solution is prepared by dissolving the insulating coating material in an organic solvent or the like and the dilute resin solution and the iron powder are mixed together such that a predetermined coating amount is obtained, followed by drying. When the insulating coating material is phosphoric acid, aluminium phosphate, magnesium phosphate, or the like, the following method can be used: a method in which the insulating coating layer is formed on the surface of the iron powder in such a manner that the insulating coating material is sprayed on the iron powder heated and mixed in a mixer.

The insulating coating layer, which is formed on the surface in the insulating coating-forming step, may be capable of maintaining the insulation between particles and the type thereof need not be particularly limited. The following layers can be exemplified as a preferable insulating coating material: a glassy insulating amorphous layer including a base containing silicone, a metal phosphate, or a metal borate; a crystalline insulating layer including a base containing SiO₂ or a metal oxide such as MgO, forsterite, talc, or Al₂O₃; a glassy insulating amorphous layer including a base containing a metal phosphate or a metal borate; and a crystalline insulating layer including a base containing SiO₂ or a metal oxide such as MgO, forsterite, talc, or Al₂O₃.

In particular, silicone is resin with excellent heat resistance, can strongly insulate particles from each other even if the thickness of a coating layer is small, and can be molded into an iron powder core with extremely low iron loss. In order to achieve such effects, a silicone coating layer is preferably formed such that the amount of resin is 0.1 parts by mass or more with respect to 100 parts by mass of the iron powder for iron powder cores according to an embodiment of the present invention. Meanwhile, the amount of the coating layer is too large, the density of the compact is low and the magnetic flux density is adversely affected in some cases. Therefore, the silicone coating layer is preferably formed such that the amount of resin is 0.5 parts by mass or less with respect to 100 parts by mass of a source powder.

As described above, in aspects of the present invention, an iron powder, capable of manufacturing an iron powder core with low iron loss and particularly low hysteresis loss, for iron powder cores can be obtained in such a manner that orientations are measured in a cross section of a compact formed with a molding pressure of 0.98 GN/m² by electron backscatter diffraction (EBSD) and the average of KAMs (Kernel Average Misorientations) calculated from measurement results of the orientations using EBSD analysis software is adjusted to 3.00° or less. Adjusting the average of the KAMs, e.g., to 3.00° or less allows the iron loss to be less than 80 W/kg. When the iron loss is less than 80 W/kg, a high-efficiency motor equivalent in level to one manufactured using electrical steel sheets can be manufactured using an iron powder core.

The iron powder for iron powder cores according to aspects of the present invention is loaded into a die and is press-molded into a desired dimensional shape (iron powder core shape), and whereby an iron powder core is obtained. A press-molding method need not be particularly limited and usual molding methods such as a room-temperature molding method and a die lubrication molding method can be used. The molding pressure is appropriately set depending on applications and is preferably 10 t/cm² (0.98 GN/m²) or more when high powder density is needed. The molding pressure is more preferably 15 t/cm² (1.47 GN/m²) or more.

Before press molding, a lubricant is preferably applied to a wall of a die or added to the iron powder as needed. This enables the friction between the die and the iron powder to be reduced during press molding, suppresses the reduction in density of a compact, enables friction to be reduced when the compact is ejected from the die, and enables the compact (iron powder core) to be prevented from being cracked during ejection. The following materials can be exemplified as preferable lubricants: metal soaps such as lithium stearate, zinc stearate, and calcium stearate and waxes such as fatty acid amides.

A molded iron powder core is heat-treated for the purpose of reducing the hysteresis loss and the purpose of increasing the strength. In the heat treatment, the iron powder core is preferably held at a temperature of 600° C. to 800° C. for 5 min to 120 min. A heating atmosphere is not particularly limited and may be determined depending on applications. The heating atmosphere is preferably an air atmosphere, an inert atmosphere, a reducing atmosphere, or a vacuum atmosphere. A step of holding a constant temperature may be set during heating or cooling in the heat treatment.

In aspects of the present invention, a target iron powder can be evaluated as powder capable of manufacturing an iron powder core with low iron loss in the case where the target iron powder is molded into a compact with a molding pressure of 0.98 GN/m², orientations are measured in a cross section of the compact by electron backscatter diffraction (EBSD), and the average of KAMs (kernel average misorientations) calculated from measurement results of the orientations using EBSD analysis software is 3.00° or less. In this way, in aspects of the present invention, the KAM can be calculated in such a manner that EBSD measurement is performed using a ring-shaped compact formed with a molding pressure of 0.98 GN/m² as a target. The KAM can also be calculated in such a manner that EBSD measurement is performed under different conditions using a compact formed with a molding pressure other than 0.98 GN/m² or a compact with a different shape as a target. In this case, it is preferable that correspondences with measurement results of iron loss are checked and the KAM evaluated as an iron powder capable of manufacturing an iron powder core with low iron loss is reviewed.

The present invention is further described below with reference to non-limiting examples of embodiments of the invention.

### EXAMPLES

### Example 1

Pure iron powders having a composition containing components shown in Table 1, the remainder being Fe and inevitable impurities, were prepared by a water-atomizing method.

TABLE 1

| Iron | Composition (mass percent) | | | | | | | | |
|---|---|---|---|---|---|---|---|---|---|
| powder | C | Si | Mn | P | S | Al | N | O | Cr |
| A | 0.005 | 0.002 | 0.05 | 0.005 | 0.003 | 0.003 | 0.001 | 0.08 | 0.04 |
| B | 0.012 | 0.006 | 0.04 | 0.015 | 0.005 | 0.005 | 0.004 | 0.05 | 0.03 |
| C | 0.01 | 0.008 | 0.08 | 0.01 | 0.004 | 0.004 | 0.003 | 0.06 | 0.02 |
| D | 0.01 | 0.019 | 0.05 | 0.012 | 0.003 | 0.003 | 0.002 | 0.06 | 0.03 |
| E | 0.009 | 0.027 | 0.08 | 0.02 | 0.003 | 0.003 | 0.002 | 0.07 | 0.04 |
| F | 0.01 | 0.066 | 0.07 | 0.01 | 0.003 | 0.003 | 0.001 | 0.1 | 0.02 |
| G | 0.01 | 0.137 | 0.1 | 0.025 | 0.003 | 0.003 | 0.002 | 0.15 | 0.05 |
| H | 0.01 | 0.019 | 0.05 | 0.01 | 0.003 | 0.003 | 0.003 | 0.06 | 0.04 |

Each obtained pure iron powder was classified using a screen, specified in JIS Z 8801-1, having 250 μm openings, followed by subjecting the undersize powder (pure iron powder) to decarburization-reduction annealing. Annealing conditions for decarburization-reduction annealing were as follows: the annealing temperature was 1,050° C., the holding time was 120 min, and annealing was performed in wet hydrogen with a dew point of 60° C. from the start of annealing to a holding time of 10 min and was then performed in dry hydrogen with a dew point of −30° C. After annealing, the pure iron powders contained less than 0.003% C, 0.0005% to 0.002% N, and 0.054% to 0.150% 0 on a mass basis, the remainder being Fe and inevitable impurities.

After decarburization-reduction annealing, each obtained iron powder was pulverized. After pulverization was performed using a hummer mill, pulverization was performed using a high-speed mixer (LFS-GS-2J, manufactured by Fukae Powtech Kogyo Co.). Pulverization was performed using the high-speed mixer such that the product of the peripheral speed of a rotating body and the treatment time (peripheral speed (m/s)×treatment time (s)) was obtained as shown in Table 2.

The pulverized iron powder was further subjected to stress relief annealing. In stress relief annealing, the pulverized iron powder was treated at a temperature shown in Table 2 for 60 min. An atmosphere for stress relief annealing was a dry hydrogen atmosphere with a dew point of −30° C. or lower. Iron Powder No. 5 was aggregated because the stress relief annealing temperature was too high; hence, subsequent treatments were canceled.

The obtained iron powder was then classified using a screen, specified in JIS Z 8801-1, having 250 μm openings. The undersize powder (pure iron powder) was further classified using a screen, specified in JIS Z 8801-1, having 45 μm openings, whereby the amount (mass percent) of particles with a size of 45 μm or less was adjusted as shown in Table 2.

The obtained iron powder was measured for apparent density, the amount of inclusions in each particle (the number of inclusions per unit area), median size D50, and the hardness of the particle.

### (1) Apparent Density

The apparent density was measured by a method in accordance with JIS Z 2504.

### (2) Measurement of Inclusions

The iron powder, which was a measured target, was embedded in a thermoplastic resin, whereby an iron powder-containing resin solid was prepared. A cross section of the iron powder-containing resin solid was polished and was then corroded, a cross-sectional microstructure of each particle in the iron powder was observed with a backscattered electron image using a scanning electron microscope (a magnification of 1,000 times to 5,000 times), and at least five fields of view were imaged. A photograph obtained in each field of view was image-processed, whereby the number (inclusions/m²) of inclusions per unit area was determined. A size distribution of the inclusions was determined and a size below and above which the number of particles becomes equal, that is, the median size D50 (m) was determined. Values obtained in each field of view were averaged and the average was defined as a value of the iron powder. The size of the inclusions used was the equivalent circle diameter approximated from the area of each inclusion.

### (3) Average Hardness

The iron powder, which was a target to be measured, was embedded in a thermoplastic resin, whereby an iron powder-containing resin solid was prepared. A cross section of the iron powder-containing resin solid was polished, whereby a specimen for hardness measurement was prepared. The obtained specimen for hardness measurement was measured for Vickers hardness HV 0.025 in accordance with JIS Z 2244 using a Vickers hardness tester (a load of 25 gf (0.245 N)). A point in each particle was measured for hardness. At least ten powder particles were measured for hardness and the average thereof was defined as the hardness of the iron powder.

Obtained results are shown in Table 2.

In Iron Powder No. 2, the number of particles with a size of 45 μm or less is outside a preferable range (10% by mass or less). In Iron Powder No. 3, pulverization conditions are above a preferable range and therefore the Vickers hardness is outside a preferable range (80 HV 0.025 or less). In Iron Powder No. 4, pulverization conditions are below a preferable range and therefore the apparent density is outside a preferable range (4.0 Mg/m³ or more). In Iron Powder No. 8, the stress relief annealing temperature is below a preferable range (500° C. or higher) and therefore the Vickers hardness is outside a preferable range (80 HV 0.025 or less). In Iron Powders No. 9, No. 10, No. 11, and No. 12, in which the content of Si is outside a preferable range, the amount of the inclusions is large and the product {the number NA (inclusions/m²) of the inclusions per unit area×the median size D50 (m)} is outside a preferable range (10,000 inclusions/m² or less). In Iron Powders No. 1, No. 6, and No. 7, all items are within preferable ranges. Iron Powder No. 13 is an iron powder produced by a conventional process in which additional pulverization and stress relief annealing are not performed.

These iron powders were insulation-coated with silicone. Silicone was dissolved in toluene, whereby a dilute resin solution containing 1.0% by mass of resin was prepared. Each iron powder was mixed with the dilute resin solution such that an insulating coating layer was 0.5 parts by mass with respect to 100 parts by mass of the iron powder, followed by drying in air and then baking resin at 200° C. for 120 min, whereby an insulation-coated iron powder, in which an insulating coating layer made of silicone was placed on the surface of each particle in the iron powder, was obtained.

These insulation-coated iron powders were molded with a molding pressure of 10 t/cm² (0.98 GN/m²) by die lubrication, whereby ring-shaped compacts (an outside diameter of 38 mmφ, an inside diameter of 25 mmφ, and a height of 6 mm) were obtained.

A specimen (a 5 mm square cross section) was taken from each of these compacts and was embedded in a thermosetting resin containing carbon such that an observation surface was perpendicular to a compression direction. A cross section thereof was polished and orientations of powder particles were measured in a scanning electron microscope equipped with a field-emission filament by electron backscatter diffraction (SEM/EBSD) (EBSD measurement). The KAM was calculated from measurement results using EBSD analysis software (OIM Analysis developed by TSL Solutions).

The KAM was calculated under conditions below.

The polished specimen was loaded into a SEM equipped with an OIM system. In a field of view with a size of 500 μm×500 μm, the misorientation between an arbitrary point in a grain and each of first to tenth adjacent points around the arbitrary point was measured with an analysis step of 0.25 μm. All obtained measurements were arithmetically averaged, whereby the average KAM of the iron powder was obtained. Among the obtained measurements, measurement points which had a CI of 0.2 or less and which were low in reliability were eliminated. The maximum misorientation was set to 5°. Only measurement points in the grain were used, excluding grain boundaries.

Obtained results are shown in Table 2.

TABLE 2

| | | | | Stress relief annealing | | Properties of iron powder | |
|---|---|---|---|---|---|---|---|
| | | Percentage | Pulverization | treatment | | Inclusions | |
| Iron | Type of | of Si in | treatment | Annealing | | Number NA | Median |
| powder | iron | iron powder | Product | temperature | | of inclusions | diameter D50 |
| No. | powder | (mass percent) | (m)* | (° C.) | Aggregation | (inclusions/m²) | (μm) |
| 1 | A | 0.002 | 21500 | 900 | Not | 1.975 × 10¹⁰ | 0.30 |
| | | | | | aggregated | | |
| 2 | B | 0.006 | 10000 | 900 | Not | 2.586 × 10¹⁰ | 0.26 |
| | | | | | aggregated | | |
| 3 | B | 0.006 | 25500 | 900 | Not | 2.778 × 10¹⁰ | 0.25 |
| | | | | | aggregated | | |
| 4 | B | 0.006 | 500 | 900 | Not | 2.643 × 10¹⁰ | 0.26 |
| | | | | | aggregated | | |
| 5 | C | 0.008 | 1500 | 1000 | Aggregated | — | — |
| 6 | C | 0.008 | 1500 | 900 | Not | 2.468 × 10¹⁰ | 0.27 |
| | | | | | aggregated | | |
| 7 | C | 0.008 | 1500 | 600 | Not | 2.468 × 10¹⁰ | 0.27 |
| | | | | | aggregated | | |
| 8 | C | 0.008 | 1500 | 400 | Not | 2.468 × 10¹⁰ | 0.27 |
| | | | | | aggregated | | |
| 9 | D | 0.019 | 1500 | 900 | Not | 6.000 × 10¹⁰ | 0.18 |
| | | | | | aggregated | | |
| 10 | E | 0.027 | 1500 | 900 | Not | 6.739 × 10¹⁰ | 0.17 |
| | | | | | aggregated | | |
| 11 | F | 0.066 | 10000 | 900 | Not | 8.602 × 10¹⁰ | 0.18 |
| | | | | | aggregated | | |
| 12 | G | 0.137 | 1500 | 900 | Not | 1.884 × 10¹¹ | 0.18 |
| | | | | | aggregated | | |
| 13 | H | 0.019 | | | | 5.900 × 10¹⁰ | 0.18 |

| | Properties of iron powder | | | | | |
|---|---|---|---|---|---|---|
| | | | | Particle size | | |
| | | | | distribution | | |
| | | | | Percentage of | | |
| | | Density | Hardness | particles with | Compact | |
| Iron | Inclusions | Apparent | Vickers | a size of 45 μm | Average | |
| powder | NA × D50 | density | hardness | or less | KAM | |
| No. | (inclusions/m) | (Mg/m³) | HV 0.025 | (mass percent) | (°) | Remarks |
| 1 | 5925 | 4.4 | 70 | 1 | 2.21 | Example |
| 2 | 6723 | 4.3 | 72 | 13 | 3.36 | Comparative |
| | | | | | | example |
| 3 | 6944 | 4.4 | 86 | 3 | 3.26 | Comparative |
| | | | | | | example |
| 4 | 6872 | 3.6 | 72 | 4 | 3.43 | Comparative |
| | | | | | | example |
| 5 | — | — | — | — | — | Comparative |
| | | | | | | example |
| 6 | 6699 | 4.2 | 74 | 5 | 2.58 | Example |
| 7 | 6699 | 4.2 | 79 | 6 | 2.90 | Example |
| 8 | 6699 | 4.2 | 89 | 4 | 3.70 | Comparative |
| | | | | | | example |
| 9 | 10909 | 4.2 | 78 | 5 | 3.01 | Comparative |
| | | | | | | example |
| 10 | 11672 | 4.2 | 80 | 3 | 3.02 | Comparative |
| | | | | | | example |
| 11 | 15641 | 4.3 | 83 | 2 | 3.14 | Comparative |
| | | | | | | example |
| 12 | 33912 | 4.2 | 89 | 4 | 3.68 | Comparative |
| | | | | | | example |
| 13 | 10620 | 2.9 | 80 | 16.4 | 3.80 | Comparative |
| | | | | | | example |

*Product: the product of the peripheral speed of a rotating body and the treatment time (peripheral speed (m/s) × treatment time (s)).

In the compacts made from Iron Powder No. 1, No. 6, and No. 7 (examples), the average KAM is 3.00° or less. However, in the iron powders other than those, the average KAM is more than 3.00°.

Separately from the above compacts, iron powders having properties shown in Table 2 were molded with a molding pressure of 15 t/cm² (1.47 GN/m²) by die lubrication, whereby ring-shaped compacts (an outside diameter of 38 mmφ, an inside diameter of 25 mmφ, and a height of 6 mm) were obtained. The obtained compacts were heat-treated at 600° C. for 45 min (in a nitrogen atmosphere), whereby specimens for iron loss measurement were obtained. These specimens for iron loss measurement were subjected to wire winding (a primary winding of 100 turns and a secondary winding of 40 turns), were measured for hysteresis loss using a direct-current magnetizer (1.0 T, a direct-current magnetizer manufactured by Metron, Inc.), and were measured for iron loss using a high-frequency iron loss-measuring system (1.0 T, 1 kHz, a high-frequency iron loss-measuring system manufactured by Metron, Inc.). Obtained results are shown in Table 3. The KAMs of these compacts are also shown in Table 3.

TABLE 3

| Iron | | | | Iron | |
|---|---|---|---|---|---|
| powder | Molten metal | Average | Hysteresis | loss | |
| No. | No. | KAM (°) | loss (W/kg) | (W/kg) | Remarks |
| 1 | A | 2.21 | 42.0 | 68.1 | Example |
| 2 | B | 3.36 | 78.0 | 96.1 | Comparative |
| | | | | | example |
| 3 | B | 3.26 | 60.1 | 91.6 | Comparative |
| | | | | | example |
| 4 | B | 3.43 | 70.0 | 99.7 | Comparative |
| | | | | | example |
| 5 | C | — | | — | Comparative |
| | | | | | example |
| 6 | C | 2.58 | 46.3 | 73.2 | Example |
| 7 | C | 2.90 | 49.9 | 78.0 | Example |
| 8 | C | 3.70 | 92.3 | 120.0 | Comparative |
| | | | | | example |
| 9 | D | 3.01 | 53.0 | 82.8 | Comparative |
| | | | | | example |
| 10 | E | 3.02 | 54.9 | 81.5 | Comparative |
| | | | | | example |
| 11 | F | 3.14 | 59.1 | 86.7 | Comparative |
| | | | | | example |
| 12 | G | 3.68 | 98.2 | 119.5 | Comparative |
| | | | | | example |
| 13 | H | 3.80 | 98.0 | 159.0 | Comparative |
| | | | | | example |

In all examples, the hysteresis loss can be adjusted to less than 50 W/kg; the iron loss is less than 80 W/kg; and magnetic cores, having excellent iron loss properties, equivalent in level to or lower in level (less than 80 W/kg) than an iron powder core obtained by stacking electrical steel sheets with a thickness of 0.35 mm are obtained.

### Example 2

Iron Powder No. 1 (refer to Table 2) used in Example 1 was used as a source powder. The source powder was insulation-coated with silicone. Silicone was dissolved in toluene, whereby a dilute resin solution containing 1.0% by mass of resin was prepared. An iron powder was mixed with the dilute resin solution such that the amount of the resin was 0.10 parts to 0.25 parts by mass with respect to 100 parts by mass of the iron powder, followed by drying in air. Furthermore, the resin was baked at 200° C. for 120 min in air, whereby insulation-coated iron powders in which an insulating coating layer made of silicone was placed on the surface of each particle in the iron powder were obtained.

These insulation-coated iron powders were molded with a molding pressure of 10 t/cm² (0.98 GN/m²) by die lubrication, whereby ring-shaped compacts (an outside diameter of 38 mmφ, an inside diameter of 25 mmφ, and a height of 6 mm) were obtained. The obtained ring-shaped compacts were heat-treated at 600° C. for 45 min (in a nitrogen atmosphere), whereby specimens for iron loss measurement were obtained. These specimens for iron loss measurement were subjected to wire winding (a primary winding of 100 turns and a secondary winding of 40 turns), were measured for hysteresis loss using a direct-current magnetizer (1.0 T, a direct-current magnetizer manufactured by Metron, Inc.), and were measured for iron loss using a high-frequency iron loss-measuring system (1.0 T, 1 kHz, a high-frequency iron loss-measuring system manufactured by Metron, Inc.). Obtained results are shown in Table 4. In Table 4, the eddy current loss (W/kg) was determined by subtracting the hysteresis loss (W/kg) from the iron loss (W/kg).

TABLE 4

| Iron | | Amount | | | | | |
|---|---|---|---|---|---|---|---|
| pow- | Iron | of | Aver- | | Eddy | Hyster- | |
| der | pow- | resin* | age | Iron | current | esis | |
| core | der | (mass | KAM | loss | loss | loss | |
| No. | No. | parts) | (°) | (W/kg) | (W/kg) | (W/kg) | Remarks |
| A1 | 1 | 0.10 | 2.21 | 75.8 | 31.2 | 44.6 | Example |
| A2 | 1 | 0.15 | 2.21 | 74.2 | 30.1 | 44.1 | Example |
| A3 | 1 | 0.25 | 2.21 | 73.6 | 29.8 | 43.8 | example |

*The mass parts of resin with respect to 100 mass parts of an iron powder.

It is clear that the hysteresis loss can be adjusted to less than 50 W/kg in such a manner that 0.1 parts by mass or more of an insulating coating layer is formed on the surface of an iron powder according to aspects of the present invention with respect to 100 parts by mass of the iron powder using silicone as an insulating coating layer. It is also clear that magnetic cores having an iron loss level (less than 80 W/kg) equal to or less than the iron loss level of an iron powder core obtained by stacking electrical steel sheets are obtained.

1. An iron powder for iron powder cores, wherein orientations are measured in a cross section of a compact formed with a molding pressure of 0.98 GN/m² by electron backscatter diffraction and an average of Kernel Average Misorientations calculated from measurement results of the orientations using electron backscatter diffraction analysis software is 3.00° or less.

2. The Iron powder for iron powder cores according to claim 1,
wherein the iron powder contains 10% by mass or less of particles with a size of 45 μm or less,
an average hardness is 80 HV 0.025 or less in Vickers hardness,
a product of the number (inclusions/m²) of inclusions per unit area and the median size D50 (m) of the Inclusions is 10,000 (inclusions/m) or less, and
apparent density is 4.0 Mg/m³ or more.

3. The iron powder for iron powder cores according to claim 1, wherein the iron powder contains 0.01% or less Al, 0.01% or less Si, 0.1% or less Mn, and 0.05% or less Cr on a mass basis, the remainder being Fe and inevitable impurities.

4. The iron powder for iron powder cores according to claim 2, wherein the iron powder contains 0.01% or less Al, 0.01% or less Si, 0.1% or less Mn, and 0.05% or less Cr on a mass basis, the remainder being Fe and inevitable impurities.

5. The iron powder for iron powder cores according to claim 1, wherein the iron powder has an insulating coating layer on a surface.

6. The iron powder for iron powder cores according to claim 2, wherein the iron powder has an insulating coating layer on a surface.

7. The iron powder for iron powder cores according to claim 3, wherein the iron powder has an insulating coating layer on a surface.

8. The iron powder for iron powder cores according to claim 4, wherein the iron powder has an Insulating coating layer on a surface.

9. The iron powder for iron powder cores according to claim 5, wherein the insulating coating layer is a silicone coating layer.

10. The iron powder for iron powder cores according to claim 6, wherein the insulating coating layer is a silicone coating layer.

11. The iron powder for iron powder cores according to claim 7, wherein the insulating coating layer is a silicone coating layer.

12. The iron powder for iron powder cores according to claim 8, wherein the insulating coating layer is a silicone coating layer.

13. The iron powder for iron powder cores according to claim 9, wherein the silicone coating layer is 0.1 parts by mass or more with respect to 100 parts by mass of the iron powder for iron powder cores.

14. The iron powder for Iron powder cores according to claim 10, wherein the silicone coating layer is 0.1 parts by mass or more with respect to 100 parts by mass of the Iron powder for iron powder cores.

15. The iron powder for iron powder cores according to claim 11, wherein the silicone coating layer is 0.1 parts by mass or more with respect to 100 parts by mass of the iron powder for iron powder cores.

16. The iron powder for iron powder cores according to claim 12, wherein the silicone coating layer is 0.1 parts by mass or more with respect to 100 parts by mass of the iron powder for iron powder cores.

17. A method for selecting an iron powder for Iron powder cores, comprising:
molding a target iron powder into a compact,
measuring orientations in a cross section of the compact by electron backscatter diffraction, and
evaluating an iron powder capable of manufacturing a low iron loss iron powder core using Kernel Average Misorientations calculated from measurement results of the orientations by using electron backscatter diffraction analysis software.

18. A method for selecting an iron powder for iron powder cores, comprising:
molding a target iron powder into a compact with a molding pressure of 0.98 GN/m²,
measuring orientations in a cross section of the compact by electron backscatter diffraction, and
evaluating the iron powder as capable of manufacturing a low iron loss iron powder core when the average of Kernel Average Misorientations calculated from measurement results of the orientations by using electron backscatter diffraction analysis software is 3.00° or less.
